(19) United States
(12) Patent Application Publication
(10) Pub. No.: US 2023/0059006 A1
(43) Pub. Date: Feb. 23, 2023

(54) FASHION PRODUCT RECOMMENDATION METHOD, APPARATUS, AND SYSTEM

(71) Applicant: ODD CONCEPTS INC., Seoul (KR)

(72) Inventor: Ae Ri YOO, Namyangju-si (KR)

(73) Assignee: ODD CONCEPTS INC., Seoul (KR)

(21) Appl. No.: 17/795,690

(22) PCT Filed: Jan. 26, 2021
(86) PCT No.: PCT/KR2021/000989

§ 371 Date: Jul. 27, 2022

(30) Foreign Application Priority Data
Jan. 30, 2020 (KR) 10-2020-0011187

(51) Int. Cl. G06Q 30/06

(52) U.S. Cl. CPC G06Q 30/0631; G06Q 30/0641

(57) ABSTRACT

The present invention relates to a fashion product recommendation method for generating first recommended product information and second recommended product information, on which the preference of a user regarding a specific fashion product is reflected, the fashion product recommendation method comprising the steps of: generating, for each product category, attribute categories including at least one piece of attribute information that is a factor characteristically considered when the user selects a fashion product; performing a tournament regarding fashion items including at least one of the attribute categories and assigning a weight to the attribute information to generate the first recommended product information; and additionally assigning a weight to the attribute information according to a filtering result of the user to generate the second recommended product information.

### TECHNICAL FIELD

The present invention relates to a method of recommending a fashion product. Specifically, the present invention relates to a system for recommending a fashion product that is capable of generating attribute categories such as a neckline, an arm length, a hem length, and a color according to product categories of fashion items, such as tops, bottoms, bags, and shoes, primarily making a survey of user preference through a tournament, and secondarily making a survey of user preference through filtering, to provide a recommended item that is identified to be preferred by a user.

### BACKGROUND ART

Based on the recent increase in wired and wireless Internet environments, business transactions such as online promotion and sales are becoming more active. In this regard, when a buyer finds a favorite product while viewing a magazine, blog, or YouTube video on a desktop or mobile terminal connected to the Internet, the buyer searches for the name of the product and the like to make a purchase. This is a case, for example, where the name of a bag that a famous actress has carried at the airport or the name of a childcare item in an entertainment program ranks high in real-time search terms on portal sites. However, in this case, the user needs to search for a product name, manufacturer, vendor, and the like by separately opening a web page for search, and without knowing precise information thereof, the user has a difficulty finding the product.

On the other hand, in order to promote products, sellers spend large amounts of money on media sponsorship and online user feedback as well as commercial advertisements. This is because word of mouth online recently acts as an important variable in product sales. However, even after spending the cost of publicity, sellers may not be allowed to disclose shopping information, such as product names and vendors. This is because it is not possible to individually obtain prior approval from media viewers about product name exposure, and indirect advertising issues may arise.

As described above, there is a need for both users and sellers to have shopping information for online product images provided in a more intuitive user interface (UI) environment.

### DISCLOSURE

### Technical Problem

Therefore, it is an object of the present invention to provide a method, apparatus, and computer program for recommending a fashion product having an improved search capability.

### Technical Solution

According to an embodiment of the present invention, there is provided a method of recommending a fashion product with improved search performance, which is a method of generating first recommended product information and second recommended product information in which a preference of a user regarding a specific fashion product is reflected, the method characterized by including: generating, for each product category, an attribute category including one or more pieces of attribute information, which is a factor characteristically considered when the user selects a fashion product; performing a tournament on a fashion item including one or more of the attribute categories and assigning a weight to the attribute information and generating the first recommended product information; and additionally assigning a weight to the attribute information according to a result of filtering by the user and generating the second recommended product information.

According to an embodiment of the present invention, there is provided a system for recommending a fashion product with improved search performance, which is a system for generating first recommended product information and second recommended product information in which a preference of a user regarding a specific fashion product is reflected, the system characterized by including: a tournament performing unit configured to generate, for each product category, an attribute category including one or more pieces of attribute information, which is a factor characteristically considered when the user selects a fashion product, perform a tournament on a fashion item including one or more of the attribute categories and assign a weight to the attribute information to generate the first recommended product information; and an attribute filtering performing unit configured to additionally assign a weight to the attribute information according to a result of filtering by the user to generate the second recommended product information.

### Advantageous Effects

According to the present invention, since a user's preference regarding an attribute category for each product category can be reflected when recommending a fashion product, the user's needs can be more accurately reflected.

According to the present invention, a user's preference regarding a combination of attribute information can be reflected, and therefore improved user-customized fashion product recommendation can be performed.

In addition, since a tournament is performed to primarily reflect a preference, and secondary filtering is performed for the user to directly add or delete attribute information, more accurate real-time fashion product recommendation can be performed in real time.

### DESCRIPTION OF DRAWINGS

FIG. 1 is a view for describing a system for recommending a fashion product according to an embodiment of the present invention.

FIG. 2 is a view for describing a configuration of a recommended product information generating unit according to an embodiment of the present invention.

FIG. 3 is a view for describing an operation of a tournament performing unit according to an embodiment of the present invention.

FIG. 4 is a view for describing an operation of an attribute filtering performing unit for a recommended item according to an embodiment of the present invention.

FIG. 5 is a view for describing an operation of an attribute filtering performing unit for a recommendation coordination according to an embodiment of the present invention.

FIG. 6 is a flowchart for describing a method of recommending a fashion product according to an embodiment of the present invention.

FIG. 7 is a detailed flowchart for describing operation S603 in FIG. 6.

FIG. 8 is a detailed flowchart for describing operation S605 in FIG. 6.

### MODE OF THE INVENTION

Embodiments according to the concept of the present invention disclosed in the present specification or application are disclosed herein in relation to specific structural and functional details, which are however merely representative for purposes of describing the example embodiments of the present invention, and the example embodiments of the present invention may be embodied in many alternate forms and are not to be construed as limited to the example embodiments of the present invention set forth herein.

While the embodiments according to the concept of the present invention are susceptible to various modifications and alternative forms, specific embodiments thereof are shown by way of example in the drawings and will herein be described in detail. However, it should be understood that there is no intent to limit the invention to the particular forms disclosed, rather the invention is to cover all modifications, equivalents, and alternatives falling within the spirit and scope of the invention.

It should be understood that, although the terms “first,” “second,” etc. may be used herein to describe various elements, these elements are not limited by these terms. These terms are only used to distinguish one element from another element. For example, without departing from the scope of the present invention, a first element could be termed a second element, and similarly, a second element could be termed a first element.

It should be understood that when an element is referred to as being “connected” or “coupled” to another element, the element can be directly connected or coupled to another element or intervening elements may be present. Conversely, when an element is referred to as being “directly connected” or “directly coupled” to another element, there are no intervening elements present. Other words used to describe a relationship between elements should be interpreted in a like fashion (i.e., “between” versus “directly between,” “adjacent” versus “directly adjacent,” etc.).

The terminology used herein is for the purpose of describing particular embodiments only and is not intended to limit the invention. As used herein, the singular forms “a,” “an,” and “one” are intended to include the plural forms as well, unless the context clearly indicates otherwise. It should be further understood that the terms “comprises,” “comprising,” “includes,” and/or “including,” when used herein, specify the presence of stated features, integers, steps, operations, elements, components and/or groups thereof, and do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having meanings that are consistent with their meanings in the context of the relevant art and are not to be interpreted in an idealized or overly formal sense unless expressly so defined herein.

In the description of the embodiments, the detailed description of constructions that are well known in the field to which the present invention pertains and are not directly related to the present invention will be omitted. This is to avoid making the subject matter of the present invention unclear and more clearly convey the subject matter by omitting unnecessary description.

Hereinafter, the present invention will be described in detail by describing exemplary embodiments of the present invention with reference to the accompanying drawings. Hereinafter, embodiments of the present invention will be described in detail with reference to the accompanying drawings.

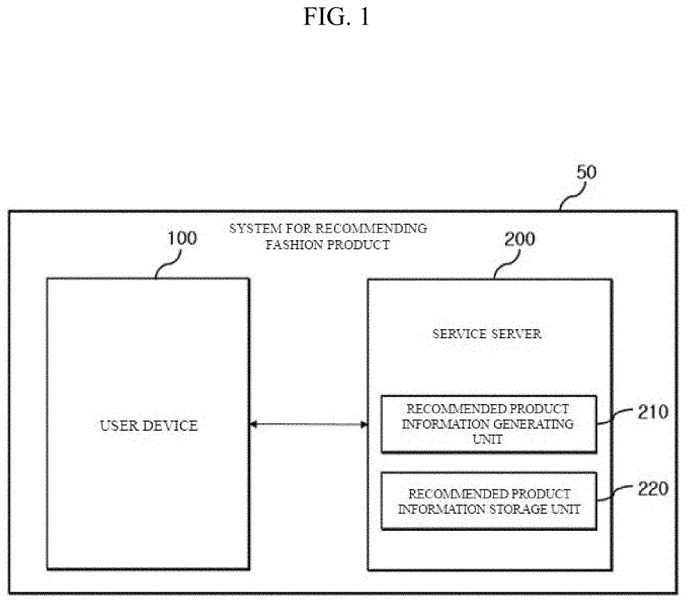

FIG. 1 is a view for describing a system for recommending a fashion product according to an embodiment of the present invention.

Referring to FIG. 1, a system 50 for recommending a fashion product may include a user device 100 and a service server 200. The user device 100 may include a mobile phone, a smart phone, a Moving Picture Experts Group (MPEG) audio layer-3 (MP3) player, a laptop computer, a desktop computer, a game console, a television (TV), a tablet personal computer (PC), an in-vehicle infotainment system, or the like.

The service server 200 may include a recommended product information generating unit 210 and a recommended product information storage unit 220.

The recommended product information generating unit 210 may generate recommended product information, which is information about a recommended product predicted to be preferred by a user. The recommended product information may be provided as an image of an individual fashion item, online shopping malls selling the individual fashion item, a brand, a price range and the like, and may also be provided as a recommended coordination image in which the recommended product is matched with other fashion products, online shopping malls, a brand, a price range and the like.

The recommended product information generating unit 210 may primarily determine a recommended product or a recommended coordination through a tournament function, and secondarily determine a recommended product or a recommended coordination through a filtering operation.

The tournament function may be a function of selecting an image more preferred by the user with respect to one or more diagnostic images provided from the service server 200.

The diagnostic image may be a fashion product image or a coordination image that includes various pieces of attribute information and attribute categories, which is arbitrarily extracted by the service server 200. In this case, the service server 200 may separately identify a preference regarding an individual fashion product and a preference regarding a set product in which a plurality of fashion products are coordinated.

A preference when a diagnostic image is provided as an individual fashion product may be different from a preference of a user when a diagnostic image is provided as a set product. There may be cases in which the user does not prefer an individual fashion item, but prefers the fashion item coordinated with other fashion items. Conversely, there may be cases in which the user prefers an individual fashion item, but does not prefer the fashion item coordinated with other fashion items.

For example, there may be a case in which a user who does not usually prefer a sweatshirt exceptionally prefers a sweatshirt matched with jeans, and a case in which a user who does not prefer a 7-piece trouser exceptionally prefers a 7-piece trouser paired with a collar-neck short-sleeved T-shirt. Conversely, there may be a case in which a user who does not usually prefer a beige trench coat does not prefer a beige trench coat matched with a dress, and a case in which a user who prefers a Chinese collar shirt does not prefer a Chinese collar shirt matched with jeans.

The user may, through an operation of selecting a favorite diagnostic image, transmit attribute information of a fashion product that the user prefers and information about an attribute category that the user considers a priority to the service server 200.

The attribute information may be a factor characteristically considered when the user selects a fashion product. The attribute category may be a set of attribute information.

The attribute categories may be present for each product category. For example, in the case of a top, the neckline, the length of the arm, the length of the cuff, the color, the pattern, the brand, and the like may be included in the attribute information. In the case of a bottom, the length of the hem, the length of the crotch, the shape of the hem, the material of the trouser, the color, the brand, and the like may be included in the attribute category.

The attribute information may be a characteristic of an individual fashion product belonging to each attribute category. For example, the neckline attribute category of the top may include off-shoulder, collar neck, China collar, and the like, and the material attribute category of the bottom may include jeans, leather pants, cotton pants, slacks and the like. The attribute category may be repeated in a plurality of fashion products. For example, the color attribute category may be repeated for tops and bottoms, and may include black, white, red, yellow, and the like.

When a user selects an image that the user prefers in the tournament operation, attribute information included in the image may be classified by product categories and transmitted to the service server 200. In this case, the attribute information and the attribute category to which the attribute information belongs may be assigned a weight according to the user's selection.

A case in which a proportion at which the user selects a collar-neck shirt of an achromatic color series giving a formal look for a category of a top is higher than a proportion at which the user selects other designs of tops is illustrated.

In this case, the recommended product information generating unit 210 may reflect weights in a color attribute category, a formal look attribute category, and a neckline attribute category for a top category, and identify the color attribute category, the formal look attribute category, and the neckline attribute category as characteristics (attribute categories) of the top that the user considers a priority.

In addition, according to the user's selection, the recommended product information generating unit 210 may reflect a weight in achromatic color attribute information in the color attribute category, a weight in shirt attribute information in the formal look attribute category, and a weight in collar neck attribute information in the neckline attribute category, and determine the achromatic color attribute information, the shirt attribute information, and the collar neck attribute information as characteristics (attribute information) of the top preferred by the user.

According to an embodiment, a weight may be reflected in the combination of a plurality of pieces of attribute information according to a user's selection. A user may not prefer specific attribute information, but may prefer the specific attribute information combined with another piece of attribute information. For example, there may be a case in which a user who does not prefer a turtle neck t-shirt may prefer a black turtle neck t-shirt as an exception.

The service server 200 may interpret each piece of attribute information and a combination of a plurality of pieces of attribute information in the same layer. Since each piece of attribute information and a combination of a plurality of pieces of attribute information may be considered within the same fashion category, a fashion category may be considered as an upper layer, and attribute information and a combination of a plurality of pieces of attribute information may be considered on the same layer as a lower layer.

In an embodiment, the recommended product information generating unit 210 may also perform an operation of analyzing non-preference attributes that are not selected by the user in the tournament operation.

The diagnostic image selected by the user may be transmitted to the service server 200 while the attribute information and the attribute category included in the diagnostic image are assigned weights. On the other hand, the diagnostic image not selected by the user may be transmitted to the service server 200 while the attribute information and the attribute category included in the diagnostic image are assigned negative weights or non-preference weights.

In the case of an attribute category, when an attribute category is not selected by the user, it may represent that the user highly considers the attribute category as a non-preferred attribute category. Accordingly, even in this case, the attribute category may be assigned a weight as an attribute category considered by the user, or may be assigned a non-preference weight.

According to an embodiment, when the user evenly selects all attribute information belonging to a specific attribute category, the attribute category may be identified as an attribute category not highly considered by the user. In this case, the corresponding attribute category may be assigned a weight having a negative value, or a non-preference or non-consideration weight. For example, when the user selects all attribute information belonging to a neckline attribute category with a similar frequency, the neckline may not be a characteristic highly considered when the user selects a top.

The user may determine a favorite image among the diagnostic images as a user-selected image. Conventionally, a user may know his or her own taste abstractly, but in order to specifically search for a fashion item reflecting the taste, the user needs to perform the search including all keywords that describe the taste.

According to an embodiment of the present invention, the user may transmit his or her taste to the service server 200 by simply selecting his or her favorite image from among a plurality of diagnostic images provided by the service server 200, thereby increasing the efficiency of the search.

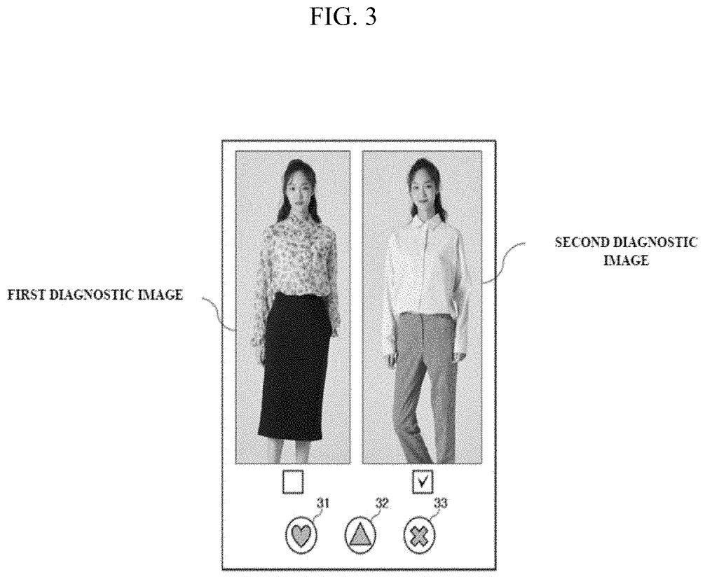

Since the preference when the diagnostic image is provided as an individual fashion product may be different from the preference when the diagnostic image is provided as a set product, the diagnostic image may be provided as an individual fashion product image, or may be provided as a coordination image in which a plurality of fashion product are matched, as will be described in FIG. 3.

Thereafter, the recommended product information generating unit 210 may generate first recommended product information using the diagnostic image selected by the user. The recommended product information generating unit 210 may generate a vector value for the first recommended product information by combining characteristic information of fashion items included in the image selected by the user.

The recommended product information generating unit 210 may generate second recommended product information through user filtering on the first recommended product information. The second recommended product information may be information for identifying a recommended item or a recommended coordination in real time by attribute information being directly added or deleted by the user.

Through such a filtering operation, attribute information unconsciously excluded by the user in the tournament operation of generating the first recommended product information may be additionally reflected, and attribute information added but not preferred by the user may be excluded. In addition, since the user may arbitrarily combine attribute information that the user desires to combine and may identify the combination in real time, there is an effect of overcoming the hassle of including all attribute information in the search.

The attribute information provided in the filtering operation may be attribute information in which a weight according to a user's selection in the tournament is reflected. When an image preferred by the user is selected in the tournament, attribute information included in the image and an attribute category including the attribute information may be classified by product categories and transmitted to the service server 200.

In the filtering operation, the user may identify attribute information for each attribute category, in which a weight is reflected, for each product category. The filtering operation may be provided separately for a recommended item or a recommended coordination. Through an operation of adding or deleting attribute information, a recommended item and a recommended coordination including the added attribute information may be identified and a recommended item and a recommended coordination in which the deleted attribute information is excluded may be identified.

According to the present invention, when recommending a fashion product, the user's preference regarding the attribute category for each product category may be reflected, and thus the user's needs can be more accurately reflected, and the user's preference regarding a combination of a plurality of pieces of attribute information can be reflected, thereby ensuring an improvement in recommending user-customized fashion products. In addition, a preference is reflected primarily through the tournament, and secondarily, attribute information is added or deleted directly by the user through filtering, and thus more accurate real-time fashion product recommendation can be performed in real time.

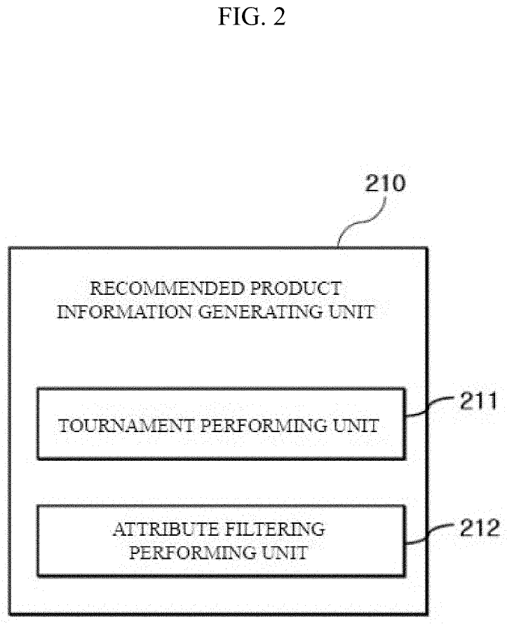

FIG. 2 is a view for describing a configuration of a recommended product information generating unit according to an embodiment of the present invention.

Referring to FIG. 2, the recommended product information generating unit 210 according to the embodiment of the present invention may include a tournament performing unit 211 and an attribute filtering performing unit 212.

The tournament performing unit 211 may perform an operation of selecting an image preferred by the user with respect to one or more diagnostic images provided from the service server.

The diagnostic image may be a fashion product image or coordination image that includes various pieces of attribute information and attribute categories, which is arbitrarily extracted by the service server. The user may, through an operation of selecting a diagnostic image, transmit attribute information of a fashion product that the user prefers and information about an attribute category that the user considers a priority to the service server 200.

The preference when the diagnostic image is provided as an individual fashion product may be different from the preference when the diagnostic image is provided as a set product.

For example, there may be cases in which the user does not prefer an individual fashion item, but prefers the fashion item coordinated with other fashion items. Conversely, there may be cases in which the user prefers an individual fashion item, but does not prefer the fashion item coordinated with other fashion items. Accordingly, the service server may separately identify a preference regarding an individual fashion product and a preference regarding a set product in which a plurality of fashion products are coordinated.

Initially, the diagnostic image may be selected based on product information previously clicked by the user and purchase history, and in the case of a newly introduced user, may be selected based on products according to current trends. Thereafter, the diagnostic image may be determined by being assigned weights by passing through a user's tournament operation and filtering operation.

The tournament performing unit 211 may, with reference to the weights assigned in the tournament and filtering operations, determine a diagnostic image that represents attribute information identified to be preferred or not preferred by the user and an attribute category identified to be particularly considered by the user. By passing through a plurality of loops, the diagnostic image may be provided to more accurately reflect the user's taste.

In an embodiment, when the user purchases an item different from a recommended item, the tournament performing unit 211 may identify that the previously recommended product process is incorrect and may re-execute product recommendation extraction.

In the process of re-executing the product recommendation, a process of extracting a diagnostic image from images of a previously purchased item or owned item may be repeated, or a diagnostic image may be directly input by a user.

In this case, the tournament performing unit 211 may provide the user device 100 with a message requesting that information about a preference diagnosis item be input, together with a message indicating that the diagnostic image does not sufficiently reflect the user's preference, a message indicating that it is difficult to provide an appropriate recommended item due to an insufficient number of user-selected images, or a message indicating that a new diagnostic image may be provided when the number of user-selected images provided as a precaution in advance is less than a set value.

The tournament performing unit 211 may reflect weights in attribute information, an attribute category, or a combination of a plurality of pieces of attribute information according to a user's selection with respect to a plurality of diagnostic images. Each piece of information in which the weight is reflected and a recommended item or recommended coordination that is primarily identified to be preferred by the user may be provided to the attribute filtering performing unit 212 as first recommended product information.

The attribute filtering performing unit 212 may receive the first recommended product information from the tournament performing unit 211 and provide a filtering function.

The attribute filtering performing unit 212 may provide attribute information included in an attribute category selected according to a weight as filtering target attribute information. In the filtering operation, the attribute information may also be provided to the user according to the weight.

In an embodiment, the attribute filtering performing unit 212 may provide the user with attribute information and an attribute category in which a weight greater than or equal to a predetermined value is reflected, together with first recommended item information, or provide the user with a preset number of pieces of attribute information and attribute categories in order from the highest weight, or may provide the user with a number of pieces of attribute information preset for each attribute category in the order of weight. The operation of extracting the attribute information and the attribute category according to the weight is not limited thereto, and may be performed according to various algorithms.

The attribute filtering performing unit 212 may filter the attribute information and the attribute category to generate second recommended item information. The user may directly add or delete attribute information and attribute categories with respect to the first recommended item information determined according to the selection of the diagnostic image, to thereby identify a recommended item and a recommended coordination in real time.

The recommended product information storage unit 220 may store recommended product information generated by the recommended product information generating unit 210. The recommended product information may include first recommended product information and second recommended product information.

The first recommended product information generated by the recommended product information generating unit 210 and stored in the recommended product information storage unit 220 may be provided to the recommended product information generating unit 210 when the filtering operation is performed. However, the recommended product information may be directly provided to the attribute filtering performing unit 212 from the tournament performing unit 211 without passing through the recommended product information storage unit 220. The generated recommended product information may be stored in the recommended product information storage unit and may be provided to the user device 100.

According to an embodiment of the present invention, the recommended product information generating unit 210 may store a product image or a style image in the form of a vector value. Specifically, the recommended product information generating unit 210 may detect a feature region of a product image or style image (interest point detection). The feature region may be a main region from which a descriptor for a feature of an image (i.e., a feature description) for determining whether images are identical or similar is extracted.

According to an embodiment of the present invention, the feature region may include a contour included in an image, an edge such as a corner among the contours, a blob distinguished from a peripheral region, a region that is invariant or covariant according to deformation of the image, or a pole darker or brighter than an ambient brightness, and may target a patch (fragment) of an image or the entire image.

Furthermore, the service server may extract a feature descriptor from the feature region (descriptor extraction). The feature descriptor may be a representation of features of an image as vector values.

According to an embodiment of the present invention, such a feature descriptor may be calculated using the position of the feature region in the corresponding image, or brightness, color, sharpness, gradient, scale, or pattern information of the feature region. For example, the feature descriptor may be calculated by converting a brightness value of the feature region, a change value or distribution value of the brightness, and the like into a vector.

Meanwhile, according to an embodiment of the present invention, the feature descriptor for an image may be represented not only as a local descriptor based on the feature region as described above, but also as a global descriptor, a frequency descriptor, a binary descriptor, or a neural network descriptor.

More specifically, the feature descriptor may include a global descriptor that converts the brightness, color, sharpness, gradient, scale, and pattern information, of an entire image, each region of an image divided by an arbitrary criterion, or each feature region into vector values for extraction.

For example, the feature descriptor may include a frequency descriptor that converts the numbers of times previously identified specific descriptors are included in an image, the number of times that a global feature, such as a conventionally defined color table, is included, and the like into vector values for extraction; a binary descriptor that extracts, in bit units, whether each descriptor is included or the size of each element value constituting the descriptor is larger or smaller than a specific value and converts the extraction into an integer type for use; and a neural network descriptor that extracts image information used for learning or classification in a layer of a neural network.

Machine learning is one field of artificial intelligence and may be defined as a system for learning based on empirical information, performing predictions, and improving the performance thereof and a set of algorithms for the system. A model used by the service server may be a model of such machine learning that uses one of a deep neural network (DNN), a convolutional deep neural network (CNN), a recurrent neural network (RNN), and a deep belief network (DBN).

In particular, according to an embodiment of the present invention, a feature information vector extracted from a product image or a style image may be converted to a lower dimension. For example, feature information extracted through an artificial neural network corresponds to 40,000-dimensional high-dimensional vector information, and it may be appropriate to transform the feature information into a low-dimensional vector with an appropriate range in consideration of resources required for the search.

FIG. 3 is a view for describing an operation of a tournament performing unit according to an embodiment of the present invention.

Referring to FIG. 3, a selection of a diagnostic image preferred by the user from among a plurality of diagnostic images displayed on the user device may reflect the user's tendency regarding specific attribute information. In FIG. 3, two diagnostic images (a first diagnostic image and a second diagnostic image) are illustrated, but the present invention may not be limited thereto.

Although the diagnostic image of FIG. 3 is illustrated as a coordination image, the diagnostic image according to an embodiment may be provided as an image of an individual fashion item.

The user may reflect the user's preference through a button displayed on the user interface. According to an embodiment, the reflection of user's preference may be implemented through a physical button, and may be implemented through not only a button but also dragging an image in a preset direction, clicking, or using a speech command.

A user may present a response of his or her preference in three methods: ‘Like 31,’ ‘Normal 32,’ and ‘Not good 33.’ According to embodiments, the preference may be implemented as two responses of ‘Like 31’ and ‘Not good 33,’ or may be implemented to include more or fewer than three responses.

In addition, each response may be repeatedly selected in duplicate. For example, the user may select ‘Like 31’ for all of the plurality of diagnostic images, ‘Like 31’ for only one of the plurality of diagnostic images, or ‘Not good 33’ for all of the plurality of diagnostic images. The user may check a checklist desired to reflect the preference among checklists of each diagnostic image and select a response to preference questions 31, 32, and 33, thereby three-dimensionally delivering the taste of the user.

Although FIG. 3 shows that the user checks his or her preference through the checklist, the present invention may be implemented according to various operations on the user interface, such as dragging or clicking one or more favorite diagnostic images.

Referring to FIG. 3, a case in which the user selects the second diagnostic image as his or her favorite image among the two diagnostic images is illustrated. The user may check the checklist of the second diagnostic image, and through ‘Like 31,’ transmit a response indicating that the user prefers the style of the second diagnostic image to the service server.

The service server may classify attribute categories for each product category (tops and bottoms) included in the second diagnostic image and assign weights to the attribute categories. Then, the service server identifies attribute information, which is included in the diagnostic image selected by the user as ‘Like 31,’ in the attribute categories, and assign a weight to the corresponding attribute information. Furthermore, the service server may also assign a weight to a combination of a plurality of pieces of attribute information included in the diagnostic image selected by the user as ‘Like 31.’

In the example of FIG. 3, the service server may extract a formal look attribute category, a neckline attribute category, and an arm length attribute category with respect to a top category, and assign a weight. In addition, the service server may assign a weight to shirt attribute information in the formal look attribute category, a weight to collar neck attribute information in the neckline attribute category, and a weight to ‘long’ arm length attribute information in the arm length attribute category. Furthermore, the service server may assign a weight to the combination of the collar neck attribute information and the ‘long’ arm length attribute information.

From the attribute information, the attribute category, and the combination of attribute information to which weights are assigned, first recommended product information predicted to be preferred by the user may be determined and provided to the user. In this case, the attribute filtering performing unit may be provided with the first recommended product information together with the determined attribute information, attribute category, and combination of attribute information.

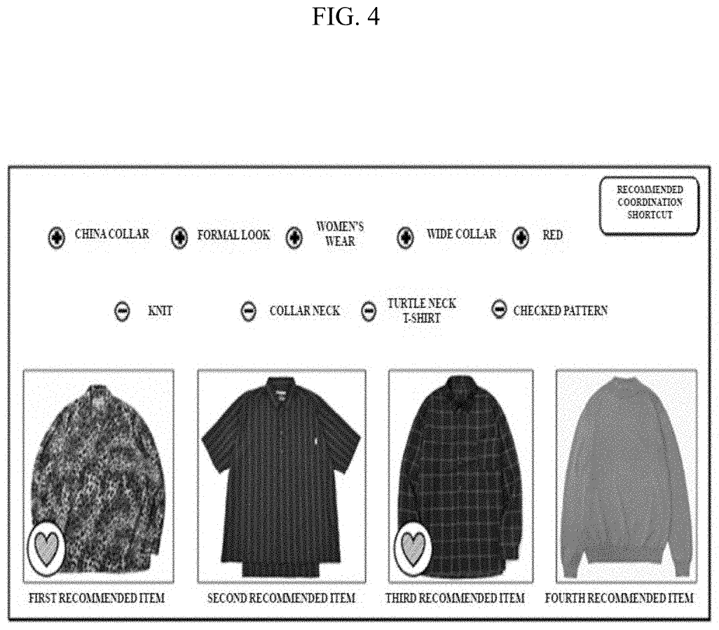

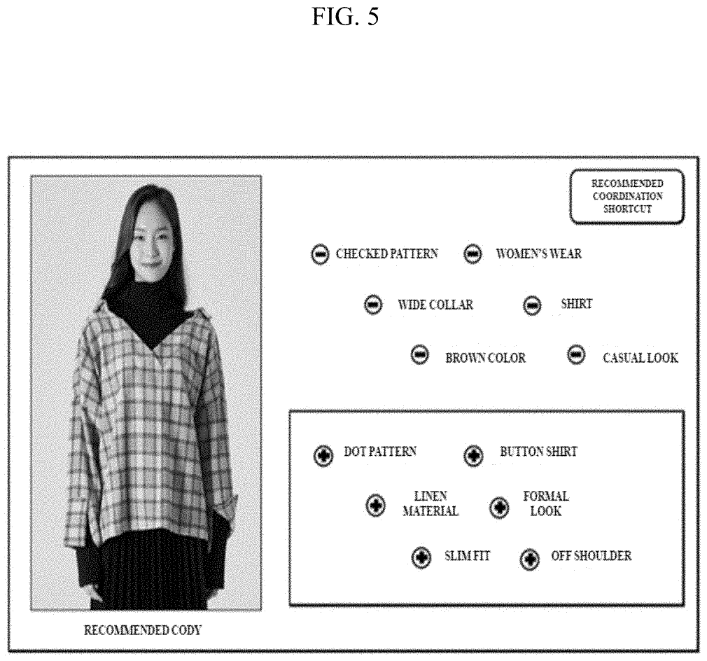

FIGS. 4 and 5 are views for describing an operation of an attribute filtering performing unit according to an embodiment of the present invention.

FIG. 4 illustrates a user interface in which first recommended item information, attribute information, attribute categories, and a combination of a plurality of pieces of attribute information are provided as recommended items. FIG. 5 illustrates a user interface in which first recommended item information, attribute information, attribute categories, and a combination of a plurality of pieces of attribute information are provided as a recommended coordination.

The user may, in the filtering operation, select attribute information he or she desires to add or attribute information to exclude. Attribute information selected by the user as (+) may be reflected in the recommended item, which is then provided to the user as second recommended product information. Conversely, attribute information selected as (−) may be excluded from the recommended first recommended product information, which is then provided to the user as second recommended product information.

In an embodiment, the user may reflect his or her preference even in the recommended item itself. One or more of the recommended items in which a preference is reflected may be selected. For example, in FIG. 4, the first recommended item and the third recommended item may be selected as preferred recommended items. The first recommended item and the third recommended item may be displayed as preferred recommended items with an indication of a heart shape or the like.

For fashion products selected as preferred recommended items, attribute information included in each fashion product is combined and used as information to be referenced in recommending a new fashion product. Attribute information may be expressed as a vector value, and the combination of attribute information may be performed according to various algorithms, such as an inner product or an external product of vector values.

In an embodiment, the recommended coordination and the recommended product may be provided to the user in the same layer. That is, the recommended coordination may not need to be provided after the recommended product is provided, and the recommended item or the recommended coordination may be provided in an arbitrary order, overlapping manner, or at the same time according to the first recommended product information. The user may move to a recommended coordination screen shown in FIG. 5, which will be described below, through a recommended coordination shortcut tab, on the upper right of the user interface.

Referring to FIG. 5, the user may identify a recommended coordination generated from the first recommended product information, and by filtering attribute information, attribute categories, or the combination of a plurality of pieces of attribute information, identify a recommended coordination in real time.

Attribute information selected by the user as (+) may be reflected in the recommended coordination, which is then provided to the user as second recommended product information. Conversely, attribute information selected as (−) may be excluded from the recommended first recommended product information, which is then provided to the user as second recommended product information.

In an embodiment, the user may exclude attribute information of checked pattern, women's wear, wide collar, shirt, brown color, and casual look according to a selection, and add attribute information of dot pattern, linen material, slim fit, button shirt, formal look, and off shoulder according to a selection.

In an embodiment, the recommended coordination and the recommended product may be provided to the user in the same layer. That is, the recommended coordination may not need to be provided after the recommended product is provided, and the recommended item or the recommended coordination may be provided in an arbitrary order, overlapping manner, or at the same time according to the first recommended product information. The user may move to a recommended item screen shown in FIG. 4, which has been described above, through a recommended item shortcut tab, on the upper right of the user interface.

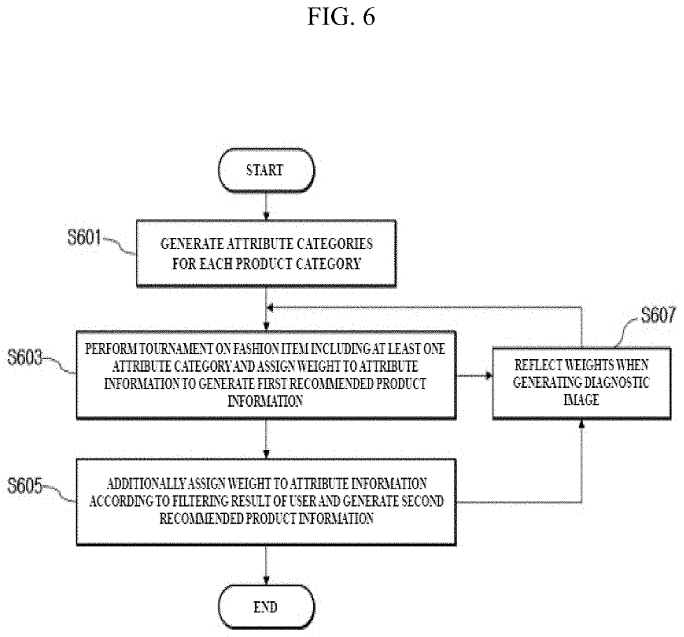

FIG. 6 is a flowchart for describing a method of recommending a fashion product according to an embodiment of the present invention.

Referring to FIG. 6, in the method of recommending a fashion product according to the embodiment of the present invention, an attribute category for each product category may be generated in operation S601.

The attribute information may be a factor characteristically considered when the user purchases a fashion product. The attribute category may be a set of attribute information.

The attribute categories may be present for each product category. For example, in the case of a top, the neckline, the arm length, the cuff length, the color, the pattern, the brand, and the like may be included as the attribute categories. In the case of a bottom, the length of the hem, the length of the crotch, the shape of the hem, the material of the trouser, the color, the brand and the like may be included as the attribute categories.

The attribute information may be a characteristic of an individual fashion product belonging to each attribute category. For example, the neckline attribute category of the top may include off-shoulder, collar neck, China collar, and the like, and the material attribute category of the bottom may include jeans, leather pants, cotton pants, slacks and the like. In addition, the attribute category may be repeated in a plurality of fashion products. For example, the color attribute category may be repeated in the top and the bottom, and may include black, white, red, yellow, and the like.

In operation S603, the service server may perform a tournament on a fashion item including at least one attribute category and assign a weight to attribute information to generate first recommended product information. Operation S603 may be a tournament operation.

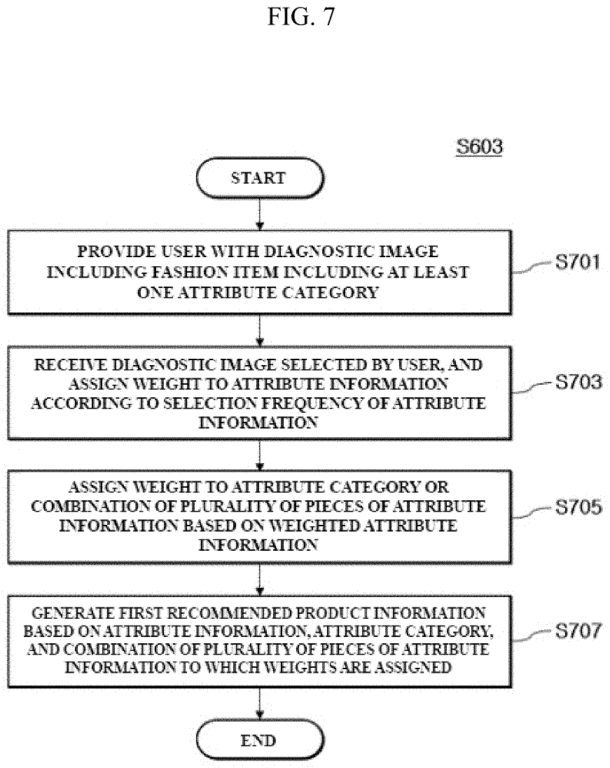

In an embodiment, an attribute category to which the weighted attribute information belongs may also be assigned a weight, and a combination of a plurality of pieces of attribute information selected by the user may also be assigned a weight. The details of operation S603 will be described in detail with reference to FIG. 7.

In operation S605, the service server may additionally assign a weight to the attribute information according to a filtering result of a user and generate second recommended product information. Operation S605 may be a filtering operation.

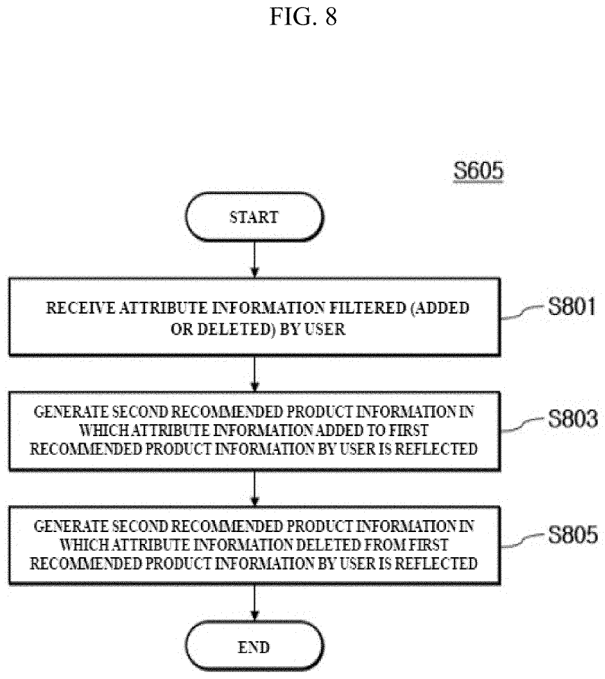

In operation S605, the user may add or delete attribute information, attribute categories, or a combination of a plurality of pieces of attribute information, to thereby identify second recommended product information in which his or her taste is reflected in real time. The details of operation S605 will be described with reference to FIG. 8.

Thereafter, in operation S607, the service server may reflect the weights, which are assigned in operations S603 and S605, when generating a diagnostic image.

As the number of times each operation is performed increases, a diagnostic image may be generated with reference to a weight that more accurately reflects the user's taste. Accordingly, the system for recommending a fashion product according to an embodiment of the present invention has an effect of learning through a feedback process and generating recommended product information through a more accurate diagnostic image.

FIG. 7 is a detailed flowchart for describing operation S603 in FIG. 6.

Referring to FIG. 7, in operation S701, the system for recommending a fashion product may provide a user with a diagnostic image including a fashion item including at least one attribute category. The diagnostic image may be generated with reference to weights assigned to the attribute information through a tournament operation S603 and a filtering operation S605.

In operation S703, the user may select a favorite diagnostic image. The service server may receive the diagnostic image selected by the user, and assign a weight to the attribute information according to the selection frequency of the attribute information. It is determined that the weighted attribute information may be a characteristic of a product preferred when the user selects a product. The attribute information may be classified by product categories, and thus generated as an attribute category.

In an embodiment, since a preference regarding an individual fashion product may be different from a preference regarding a set product, the diagnostic image may be provided as an image of an individual fashion product or a set product.

There may be cases in which the user does not prefer an individual fashion item, but prefers the fashion item coordinated with other fashion items. Conversely, there may be cases in which the user prefers an individual fashion item, but does not prefer the fashion item coordinated with other fashion items. Accordingly, the service server may separately identify a preference regarding an individual fashion product and a preference regarding a set product in which a plurality of fashion products are coordinated.

In operation S705, the system for recommending a fashion product may assign a weight to an attribute category and a combination of a plurality of pieces of attribute information based on the weighted attribute information. In FIG. 7, after attribute information is assigned a weight, an attribute category and a combination of a plurality of pieces of attribute information including the corresponding attribute information are assigned weights, but the assigning of weights of the attribute information, the attribute category, and the combination of the plurality of pieces of attribute information may be performed simultaneously.

In operation S707, the system for recommending a fashion product may generate first recommended product information based on the attribute information, attribute category, and the combination of the plurality of pieces of attribute information to which weights are assigned.

The first recommended product information may be information about a recommended item and a recommended coordination that is determined to be preferred by the user according to the user's selection of a diagnostic image in the tournament operation. The first recommended product information may be provided to the user together with the attribute information, the attribute category, and the combination of a plurality of pieces of attribute information, and may be combined by adding or deleting each piece of attribute information in a filtering operation of FIG. 8, which will be described below, to generate second recommended product information that is determined to be finally preferred by the user.

FIG. 8 is a detailed flowchart for describing operation S605 in FIG. 6.

Referring to FIG. 8, in operation S801, the system for recommending a fashion product may receive attribute information filtered (added or deleted) by the user. The filtering target may include not only attribute information, but also an attribute category and a combination of a plurality of pieces of attribute information.

Since the user additionally reflects his or her preference in the first recommended product data through filtering, the user may be provided with second recommended product information that is more accurate and identifiable in real-time.

In operation S803, the system for recommending a fashion product may generate second recommended product information in which the attribute information added to the first recommended product information by the user. By performing only the tournament operation, the user may miss some attribute information without accurately reflecting his/her preference.

In operation S803, the system for recommending a fashion product may provide attribute information assigned a weight greater than or equal to a predetermined value or a preset number of pieces of attribute information in order from the highest weight as filtering target attribute information. Such attribute information may be attribute information reflected in the recommended item or recommended coordination on the user interface. The user may delete the attribute information to thereby be provided with second recommended product information in which the corresponding attribute information is not reflected, in operation S803.

In operation S805, the system for recommending a fashion product may provide attribute information, an attribute category, and a plurality of pieces of attribute information included in a diagnosis image, which has not been selected by the user or selected as normal in the tournament operation, as a filtering target. The user may add the attribute information, the attribute category, and the plurality of pieces of attribute information to generate second recommended product information in which a missing preference is reflected, in operation S805.

Specific embodiments are shown by way of example in the specification and the drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention.

1. A fashion product recommendation method for generating recommended product information reflecting a user's preference for a fashion product, the method comprising:
generating, for each product category, an attribute category including one or more pieces of attribute information, which is a factor characteristically considered when the user selects a fashion product;
obtaining a preferred information of a target user for the attribute information for each the attribute category; and
generating a recommended product information by assigning a weight to the attribute information included in the preferred information of the target user,
wherein the obtaining the preferred information of the target user further comprises:
providing a first image and a second image related to the fashion item to the target user; and
obtaining the preferred information of the target user based on a selection result for the first image and the second image,
wherein the obtaining the preferred information of the target user based on the selection result further comprises:
obtaining a preferred image based on the selection result;
obtaining a feature region of the preferred image from the preferred image;
extracting the attribute information for each attribute category from the feature region; and
obtaining the preferred information based on the extracted attribute information for each attribute category.

2. The method of claim 1, wherein the generating the recommended product information further comprises:
obtaining a selection frequency information for the attribute information of the target user based on the selection result; and
generating the recommended product information by assigning a weight to the attribute information based on the selection frequency information.

3. The method of claim 1, wherein the obtaining the preferred information of the target user further comprises:
obtaining a shopping history information of the target user; and
obtaining an initial preferred information of the target user, based on the shopping history information of the target user, from a product image clicked by the target user or purchased by the target user.

4. The method of claim 3, wherein the first image and the second image are generated based on the attribute information for each attribute category of a product included in the initial preferred information.

5. The method of claim 1, wherein the extracting the attribute information further comprises:
obtaining a feature vector corresponding to a feature of the feature region;
generating a preference vector value corresponding to the attribute information based on the feature vector; and
generating the recommended product information based on the preference vector value.

6. The method of claim 1, wherein the obtaining the preferred information of the target user further comprises:
obtaining a non-preferred image based on the selection result;
obtaining a feature region of the non-preferred image from the non-preferred image;
extracting the attribute information for each attribute category from the feature region; and
obtaining a non-preferred information based on the extracted attribute information for each attribute category.

7. The method of claim 6, wherein the generating the recommended product information further comprises:
filtering products related to the non-preferred information among products included in the recommended product information based on the non-preferred information; and
generating the recommended product information based on the filtering result;

8. The method of claim 1, wherein the obtaining the preferred information of the target user further comprises:
obtaining a selection frequency information for the attribute information of the target user based on the selection result;
providing an attribute information list to the target user by assigning a weight to the attribute information based on the selection frequency information;
obtaining an adding input or a deleting input of the target user for the attribution information included in the attribute information list; and
obtaining the preferred information based on the adding input, and a non-preferred information based on the deleting input.

9. The method of claim 8, wherein the generating the recommended product information further comprises:
filtering products related to the non-preferred information among products included in the recommended product information based on the non-preferred information; and
generating the recommended product information based on the filtering result.

10. A fashion product recommendation method for generating recommended product information reflecting a user's preference for a fashion product, the method comprising:
generating, for each product category, an attribute category including one or more pieces of attribute information, which is a factor characteristically considered when the user selects a fashion product;
obtaining a preferred information and a non-preferred information of a target user for the attribute information or the attribute category; and
generating a recommended product information based on the preferred information and the non-preferred information of the target user,
wherein the obtaining the preferred information and the non-preferred information of the target user further comprises:
providing a first image and a second image related to the fashion item to the target user;
and obtaining the preferred information of the target user from image selected among the first image and the second image, and the non-preferred information of the target user for image not selected among the first image and the second image,
wherein the generating the recommended product information further comprises:
generating a first recommended product information by assigning a weight to the attribute information included in the preferred information of the target user;
filtering products related to the non-preferred information among products included in the first recommended product information based on the non-preferred information; and
generating a second recommended product information based on the filtering result.

11. The method of claim 10, wherein the obtaining the preferred information and the non-preferred information of the target user further comprises:
obtaining a shopping history information of the target user;
obtaining an initial preferred information of the target user, based on the shopping history information of the target user, from a product image clicked by the target user or purchased by the target user; and
generating the first image and the second image based on the initial preferred information.

12. The method of claim 10, wherein the generating the first recommended product information further comprises:
generating a preference vector value corresponding to the attribute information for each attribute category included in the preferred information of the target user; and
generating the first recommended product information based on the preference vector value.

13. The method of claim 10, wherein the obtaining the preferred information and the non-preferred information of the target user further comprises:
obtaining a selection frequency information for the attribute information of the target user from the selected image;
providing an attribute information list to the target user by assigning a weight to the attribute information based on the selection frequency information;
obtaining an adding input or a deleting input of the target user for the attribution information included in the attribute information list; and
obtaining the preferred information based on the adding input, and a non-preferred information based on the deleting input.

14. The method of claim 10, wherein the generating the first recommended product information further comprises:
obtaining a selection frequency information for the attribute information of the target user based on the selection for the first image or the second image; and
generating the first recommended product information by assigning a weight to the attribute information based on the selection frequency information.
